(19) United States
(12) Patent Application Publication
(10) Pub. No.: US 2026/0177476 A1
(43) Pub. Date: Jun. 25, 2026

(54) HYPERSPECTRAL INSPECTION SYSTEM

(71) Applicant: KLA Corporation, Milpitas, CA (US)

(72) Inventors: Kuljit S. Virk, Fremont, CA (US); Abdurrahman Sezginer, Monte Sereno, CA (US)

(21) Appl. No.: 18/999,747

(22) Filed: Dec. 23, 2024

(51) Int. Cl. G01N 21/31; G01N 21/95

(52) U.S. Cl. CPC G01N 21/31; G01N 21/9505

(57) ABSTRACT

A hyperspectral inspection system is disclosed. The hyperspectral inspection system may include a broadband light source configured to emit broadband light. The hyperspectral inspection system may include a set of illumination optics configured to direct broadband light to a sample. The hyperspectral inspection system may include a hyperspectral camera assembly, and a set of imaging optics configured to collect light from the sample and direct light to the hyperspectral camera assembly to acquire multiple images of the sample at different wavelength bands. The hyperspectral camera assembly may include a set of sensors and a set of filter plates positioned in front of the set of sensors, wherein a respective filter plate is positioned in front of a respective sensor.

### TECHNICAL FIELD

The present disclosure generally relates to semiconductor wafer inspection, and, more particularly, to a hyperspectral inspection system for simultaneously acquiring multiple images from a sample at different wavelength bands.

### BACKGROUND

Traditional wafer inspection tools, such as the broadband plasma (BBP) wafer inspection tool, utilize a filter wheel to select a wavelength band for inspection. During typical operation, the filter selected remains in place until the inspection is completed, and a second filter may be selected for inspection at a different wavelength band. This approach has several disadvantages, including the need to store images acquired with the first wavelength band until images acquired with the second wavelength band are available, leading to significant storage and playback costs. Additionally, images acquired with different wavelength bands during different scans must be aligned with each other with high accuracy, which is prone to failure. This alignment strategy becomes highly susceptible to any qualitative changes due to imaging at very different wavelength bands. There are also overhead periods during which images are not acquired, such as stage turn-around time, mapping wafer x-y coordinates, mapping wafer z-height, and run-time focus calibration. It would be desirable to provide a system and method that cure the shortfalls of the previous approaches identified above.

### SUMMARY

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

A hyperspectral inspection system is disclosed. In some aspects, the hyperspectral inspection includes a broadband light source configured to emit broadband light. In some aspects, the hyperspectral inspection includes a set of illumination optics configured to direct broadband light to a sample. In some aspects, the hyperspectral inspection includes a hyperspectral camera assembly. In some aspects, the hyperspectral inspection includes a set of imaging optics configured to collect light from the sample and direct light to the hyperspectral camera assembly to acquire multiple images of the sample at different wavelength bands. In some aspects, the hyper spectral camera assembly includes a set of sensors and a set of filter plates positioned in front of the set of sensors, wherein a respective filter plate is positioned in front of a respective sensor.

### BRIEF DESCRIPTION OF THE DRAWINGS

The numerous advantages of the disclosure may be better understood by those skilled in the art by reference to the accompanying figures.

FIG. 1A illustrates a simplified schematic diagram of the hyperspectral inspection system, in accordance with one or more embodiments of the present disclosure.

FIGS. 1B and 1C illustrate a simplified schematic diagram of a hyperspectral camera assembly, in accordance with one or more embodiments of the present disclosure.

FIG. 1D illustrates a sensor of a hyperspectral camera assembly equipped with line-shaped filters, in accordance with one or more embodiments of the present disclosure.

FIG. 2 illustrates a hyperspectral inspection system, in accordance with one or more additional and/or alternative embodiments of the present disclosure.

FIG. 3 illustrates a flowchart of a method for performing hyperspectral inspection to detect defects, in accordance with one or more embodiments of the present disclosure.

FIG. 4 illustrates a conceptual view of selective deposition to enhance a defect signal during an inspection process.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

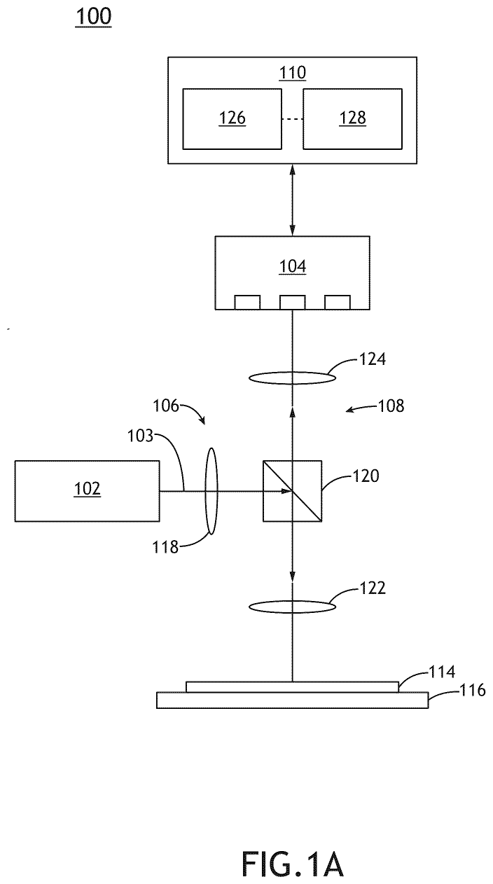

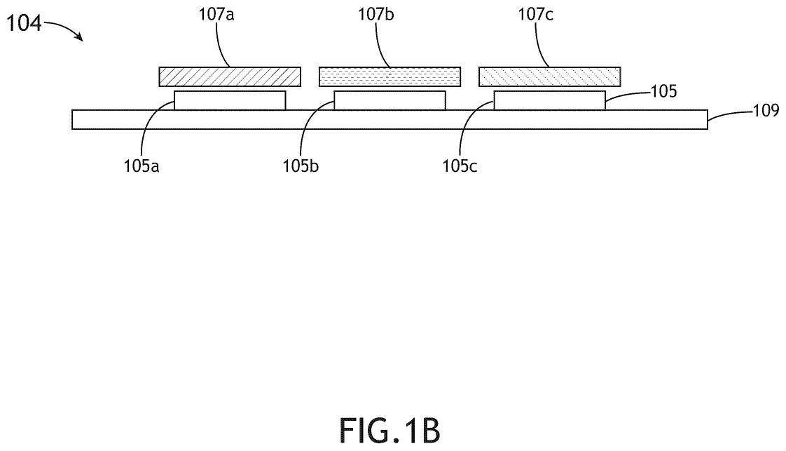

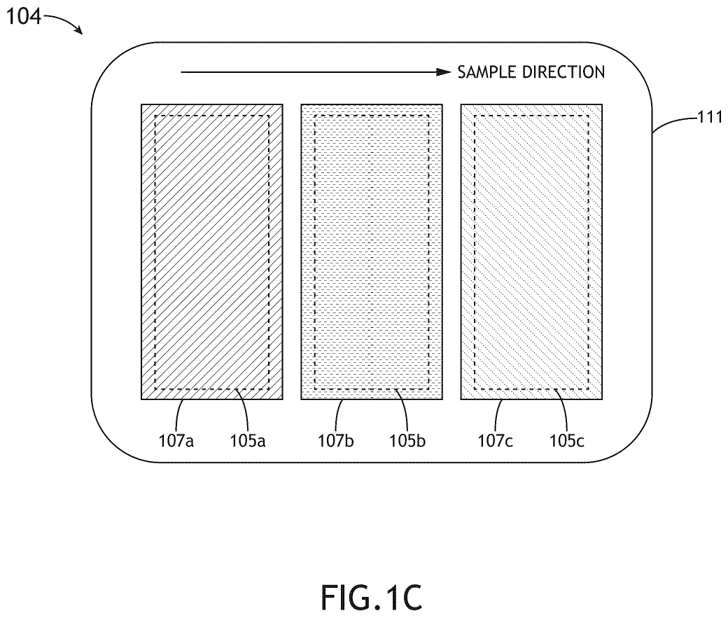

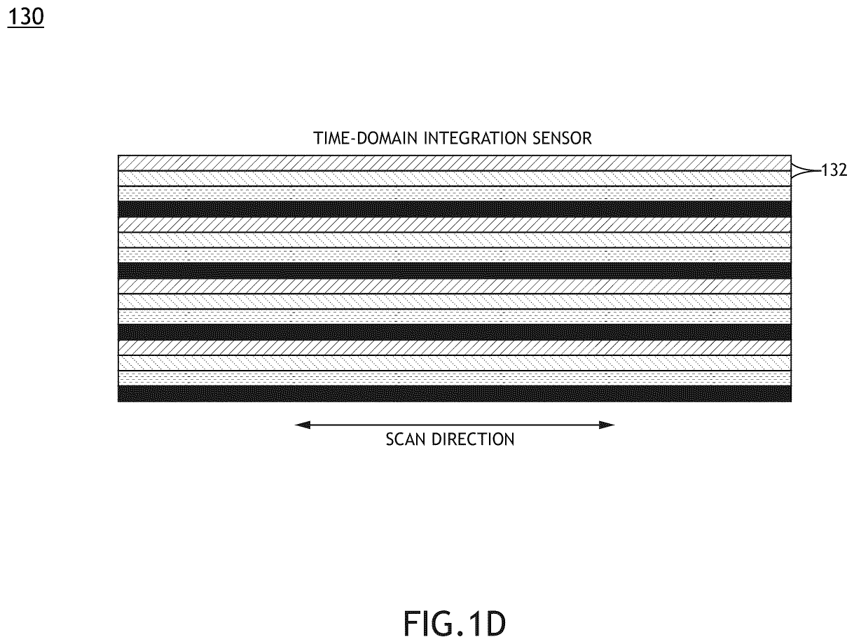

Referring generally to FIGS. 1A-3, a system and method for hyperspectral inspection is described, in accordance with one or more embodiments of the present disclosure.

Embodiments of the present disclosure are directed to a hyperspectral inspection system for simultaneous acquisition of images of a sample, such as a semiconductor wafer, at different wavelength bands and using multiple imaging modes together to detect defects with increased sensitivity. The hyperspectral inspection system may include a hyperspectral camera assembly including a set of sensors and a set of filter plates, with each sensor paired with a filter plate mounted in front of the given sensor. Embodiments of the present disclosure allow for wavelength selection to occur at the camera assembly and eliminate the need for image storage and alignment and reduce overhead periods during image acquisition. In addition, the camera assembly of the present disclosure minimizes the waste of illumination power, as light at the full, broad wavelength band may be utilized.

FIG. 1A illustrates a simplified schematic diagram of the hyperspectral inspection system 100, in accordance with one or more embodiments of the present disclosure. In embodiments, the hyperspectral inspection system 100 includes a broadband light source 102, a hyperspectral camera assembly 104, a set of illumination optics 106, and a set of imaging optics 108. Additionally, the hyperspectral inspection system 100 may include a controller 110. The hyperspectral inspection system 100 may include any broadband light source known in the art. For example, the broadband light source 102 may include, but is not limited to, a broadband laser-sustained plasma (LSP) light source. In embodiments, broadband light 103 is emitted by the broadband light source 102 and directed and focused to the sample 114 disposed on stage 116 via illumination optics 106. The imaging optics 108 collect light from the sample 114 and direct and image the collected light onto the hyperspectral camera assembly 104. In this manner, broad wavelength band light is passed through the illumination optics 106, the surface of the sample 114, and the imaging optics 108 to the set of sensors 105 of the hyperspectral camera assembly 104.

In embodiments, as shown in FIGS. 1B and 1C, the hyperspectral camera assembly 104 includes a set of sensors 105a, 105b, 105c and a set of filter plates 107a, 107b, 107c. In embodiments, the set of filter plates 107a, 107b, 107c are positioned in front of the set of sensors 105a, 105b, 105c. In this regard, each sensor 105a, 105b, 105c is equipped with a different filter plate 107a, 107b, 107c positioned in front of the sensor. For example, filter plate 107a is positioned in front of sensor 105a, filter plate 107b is positioned in front of sensor 105b, and filter plate 107c is positioned in front of sensor 105c. In embodiments, two or more of the filter plate 107a, 107b, 107c may be a different transmissive color filter. For example, the set of filter plates 107a, 107b, 107c may include a first color filter plate, a second color filter plate, and a third color filter plate. In this regard, the hyperspectral camera assembly 104 may acquire images at different wavelength bands simultaneously, with the FOV 111 of the inspection system 100 encompassing the set of sensors 105a, 105b, 105c. In embodiments, the passbands of the three filter plates, respectively, may be 190-220 nm, 220-240 nm, and 240-260 nm. Alternatively, some of the passbands of the filter plates may be the same. For example, two or more of the filter plates 107a, 107b, 107c may have a passband of 190-220 nm, while the remaining filter plate has a passband of 220-260 nm. Such an arrangement emphasizes the shorter wavelength band.

In embodiments, the set of sensors 105a, 105b, 105c form a sensor array and are mounted on a substrate 109 (e.g., circuit board). Each sensor 105a, 105b, and/or 105c may include a sensor chip (i.e., integrated circuit) containing multiple pixels. For example, a given sensor 105a, 105b, and/or 105c may contain nxm pixels (e.g., 2000×7000 pixels). One or more of the sensors 105a, 105b, and 105c may include, but are not limited to, a CCD sensor, a TDI-CCD sensor, or a CMOS sensor. In the case of a TDI-CCD sensor, the TDI-CCD based sensors 105a, 105b, 105c may scan the FOV 111 across the set of sensors 105a, 105b, 105c.

It is noted that the hyperspectral camera assembly 104 is not limited to three sensors/filter plates as depicted in FIGS. 1B-1C and it is contemplated that any number of sensors and filter plates may be implemented within the hyperspectral camera assembly 104 across any broadband range and passband ranges.

In embodiments, as shown in FIG. 1D, the hyperspectral camera assembly 104 may include a multi-pixel sensor 130. In this embodiment, the sensor 130 may be equipped with a set of line-shaped filters 132 running the entire length of the sensor 130 in the scan direction (e.g., x-direction). For example, each filter may be one pixel wide and configured to pass a particular wavelength band. For example, each filter 132 may pass a particular wavelength band in the DUV to visible wavelength range. In embodiments, the set of filters 132 includes N distinct filters which periodically repeat in the direction perpendicular to the scan direction (e.g., y-direction).

In embodiments, the optical magnification in the y-direction may be set to N times the magnification in the x-direction. Then, in each square-shaped optical pixel in the sample plane, N color information is obtained. To obtain the additional color information the N times more swaths are required to cover the sample (wafer), with an N times reduction in throughput.

Referring again to FIG. 1A, in embodiments, the illumination optics 106 are configured to direct broadband light 112 from the broadband light source 102 to the sample 114 disposed on stage 116. The illumination optics 106 may include any number and type of optical components known in the art. In embodiments, the illumination optics 106 include one or more optical elements 118, a beam splitter 120, and an objective lens 122. In this regard, illumination optics 106 may be configured to focus broadband light 103 from the broadband light source 102 onto the surface of the sample 114. The one or more optical elements 118 may include any optical element or combination of optical elements known in the art including, but not limited to, one or more mirrors, one or more lenses, one or more polarizers, one or more gratings, one or more filters, one or more beam splitters, and the like.

In embodiments, the imaging optics 108 are configured to collect light from the sample 114 and image the light onto the hyperspectral camera assembly 104. The imaging optics 108 may include any number and type of optical components known in the art. In embodiments, the imaging optics 108 include one or more optical elements 124, the beam splitter 120, and the objective lens 122. In this regard, the imaging optics 108 may be configured to focus light emanating from the sample 113 (e.g., reflected, scattered, or emitted) onto the sensors 105a, 105b, 105c of the hyperspectral camera assembly 104. The one or more optical elements 124 may include any optical element or combination of optical elements known in the art including, but not limited to, one or more mirrors, one or more lenses, one or more polarizers, one or more gratings, one or more filters, one or more beam splitters, and the like.

The controller 110 may include one or more processors 126 and a memory medium 128. The one or more processors 126 may be communicatively coupled to the set of sensors 105a, 105b, 105c. The one or more processors 126 are configured to execute a set of program instructions stored in the memory medium 128 to perform one or more steps of the present disclosure. In embodiments, the one or more processors 126 are configured to receive a set of images from the set of sensors, wherein each image is acquired at a different wavelength band. For example, the one or more processors 126 may receive one or more images from a first sensor 105a, one or more images from a second sensor 105b, and one or more images from a third sensor 105c. In embodiments, the one or more processors 126 are configured to analyze the set of images, taken at different wavelength bands, to detect one or more defects. For example, the one or more processors 126 may analyze the one or more images from the first sensor 105a, the one or more images from the second sensor 105b, and the one or more images from the third sensor 105c to detect one or more defects of the sample.

The one or more processors 126 of the present disclosure may include any one or more processing elements known in the art. In this sense, the one or more processors 126 may include any microprocessor-type device configured to execute software algorithms and/or instructions. In one embodiment, the one or more processors 126 may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium. Moreover, different subsystems of the various systems disclosed may include processor or logic elements suitable for carrying out at least a portion of the steps described throughout the present disclosure. Therefore, the above description should not be interpreted as a limitation on the present disclosure but merely an illustration.

The memory medium 128 may include any storage medium known in the art suitable for storing program instructions executable by the associated one or more processors 126. For example, the memory medium 128 may include a non-transitory memory medium. For instance, the memory medium 128 may include, but is not limited to, a read-only memory, a random-access memory, a magnetic or optical memory device (e.g., disk), a magnetic tape, a solid-state drive, and the like. In another embodiment, the memory medium 128 is configured to store one or more results and/or outputs of the various steps described herein. It is further noted that memory medium 128 may be housed in a common controller housing with the one or more processors 126. In an alternative embodiment, the memory medium 128 may be located remotely with respect to the physical location of the processors 126. For instance, the one or more processors 126 may access a remote memory (e.g., server), accessible through a network (e.g., internet, intranet, and the like)

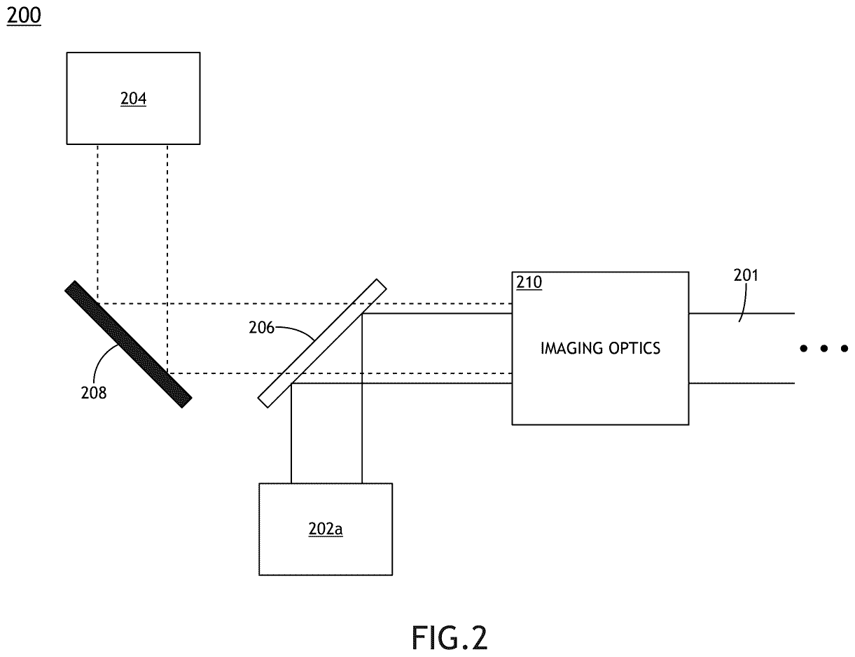

FIG. 2 illustrates a hyperspectral inspection system 200, in accordance with one or more additional and/or alternative embodiments of the present disclosure. In this embodiment, the system 200 includes a first camera 202 and a second camera 204. Broadband light from the sample is collected by the imaging optics 210 and directed downstream to a dichroic mirror 206. The dichroic mirror 206 picks off light of a first wavelength band to the first camera 202. In turn, a mirror 208 directs the remaining light to a second camera 204. In this embodiment, illumination power is not wasted.

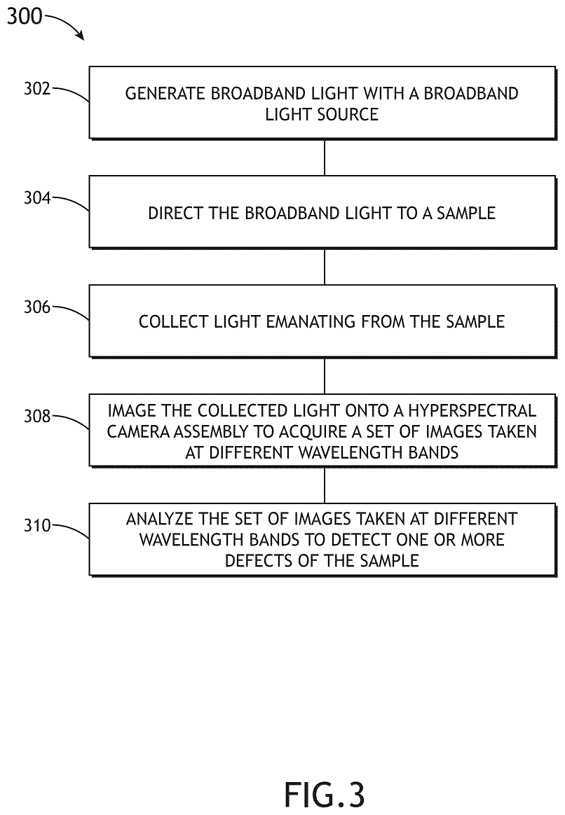

FIG. 3 illustrates a flowchart of a method 300 for performing hyperspectral inspection to detect defects, in accordance with one or more embodiments of the present disclosure. It is noted herein that the steps of method 300 may be implemented all or in part by hyperspectral inspection system 100. It is further recognized, however, that the method 300 is not limited to the hyperspectral inspection system 100 in that additional or alternative device-level embodiments may carry out all or part of the steps of method 300. In step 302, the method 300 includes generating broadband light with a broadband light source. In step 304, the method 300 includes directing the broadband light to a sample. In step 306, the method 300 includes collecting light emanating from the sample. In step 308, the method 300 includes imaging the collected light onto a hyperspectral camera assembly to acquire a set of images taken at different wavelength bands. In step 310, the method 300 includes analyzing the set of images taken at different wavelength bands to detect one or more defects of the sample.

While much of the present disclosure has been focused on a hyperspectral inspection system, it is additionally contemplated that defect signals may be increased through the implementation of selective deposition.

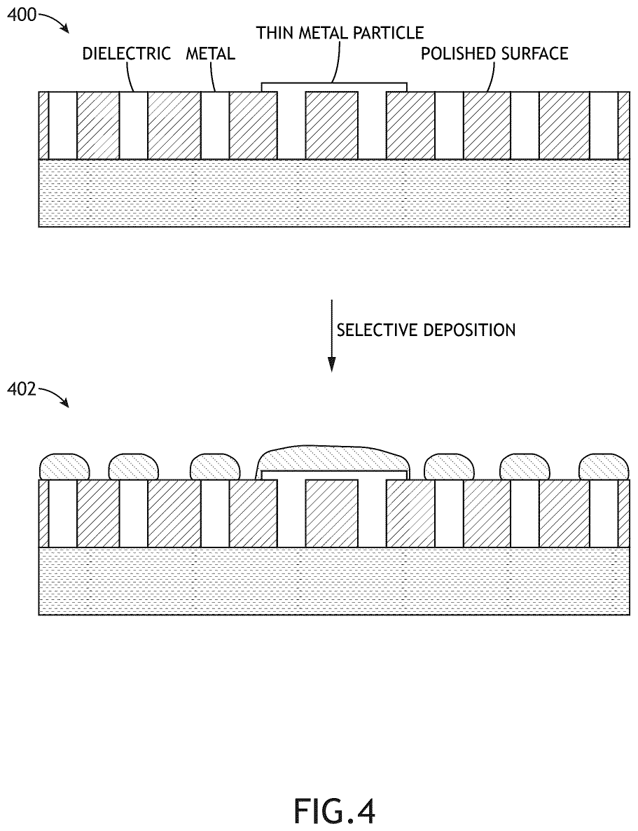

FIG. 4 illustrates a conceptual view 400 of selective deposition to enhance a defect signal during an inspection process. Chemical-Mechanical Planarization (CMP) used during semiconductor device fabrication leaves thin metal particles at the surface of a wafer. If the metal particles are so thin that they do not reflect much light, it becomes hard to detect these defects by optical inspection. In embodiments, the thickness of these particles may be increased to make them more detectible by an inspection system. In embodiments, after chemical-mechanical planarization, metal is selectively deposited on the exposed metal surfaces of the wafer by a selective atomic layer deposition (ALD) technique. The deposited metal, such as cobalt, may cover all exposed metal surfaces, not only the defect, but the deposition will thicken the defect making it more detectable. It is noted that other selective deposition techniques may be employed. For example, dielectric material may be selectively deposited on dielectric surfaces. The metal defect will block the selective dielectric on dielectric deposition. In step 402, a conceptual view of a wafer following CMP is depicted. In this view, a metal particle is located on the surface of the wafer. In step 404, metal is deposited on the surface of the wafer. The deposited metal selective adheres to the metal portions of the surface, thickening the metal structures, including the metal defect, and enhancing the inspection signal associated with the metal defect.

One skilled in the art will recognize that the herein described components, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, devices, and objects should not be taken as limiting.

Those having skill in the art will appreciate that there are various vehicles by which processes and/or systems and/or other technologies described herein can be implemented (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A hyperspectral inspection system comprising:
a broadband light source configured to emit broadband light;
a set of illumination optics configured to direct broadband light to a sample;
a hyperspectral camera assembly; and
a set of imaging optics configured to collect light from the sample and direct light to the hyperspectral camera assembly to acquire multiple images of the sample at different wavelength bands,
wherein the hyperspectral camera assembly comprises a set of sensors and a set of filter plates positioned in front of the set of sensors, wherein a respective filter plate is positioned in front of a respective sensor.

2. The hyperspectral inspection system of claim 1, wherein the broadband light source comprises a broadband laser-sustained plasma light source.

3. The hyperspectral inspection system of claim 1, wherein one or more of the set of sensors comprise at least one of a CCD sensor, a TDI-CCD sensor, or a CMOS sensor.

4. The hyperspectral inspection system of claim 1, wherein the set of filter plates comprise a set of different color filters.

5. The hyperspectral inspection system of claim 4, wherein the set of filter plates comprise a first color filter positioned in front of a first sensor, a second color filter positioned in front of a second sensor, and at least a third color filter positioned in front of at least a third sensor.

6. The hyperspectral inspection system of claim 1, wherein the set of sensors are mounted on a circuit board.

7. The hyperspectral inspection system of claim 1, further comprising:
a controller including one or more processors and memory, wherein the one or more processors are communicatively couple to the set of sensors, wherein the one or more processors are configured to:
receive a set of images from the set of sensors, wherein each image is acquired at a different wavelength band; and
analyze the set of images to detect one or more defects.

8. A hyperspectral camera assembly for acquiring multiple images at different wavelength bands comprising:
a set of sensors mounted on a substrate; and
a set of filter plates positioned in front of the set of sensors, wherein a respective filter plate is positioned in front of a respective sensor,
wherein two or more of the set of filter plates are different to acquire multiple images at different wavelength bands.

9. The hyperspectral camera assembly of claim 8, wherein one or more of the set of sensors comprise at least one of a CCD sensor, a TDI-CCD sensor, or a CMOS sensor.

10. The hyperspectral camera assembly of claim 8, wherein the set of filter plates comprise a set of different color filters.

11. The hyperspectral camera assembly of claim 10, wherein the set of filter plates comprise a first color filter positioned in front of a first sensor, a second color filter positioned in front of a second sensor, and at least a third color filter positioned in front of at least a third sensor.

12. The hyperspectral camera assembly of claim 8, wherein the substrate comprises a circuit board.

13. A method of hyperspectral inspection comprising:
generating broadband light with a broadband light source;
directing the broadband light to a sample;
collecting light emanating from the sample;
imaging collected light onto a hyperspectral camera assembly to acquire a set of images taken at different wavelength bands; and
analyzing the set of images taken at different wavelength bands to detect one or more defects of the sample.

14. The method of claim 13, wherein generating broadband light with a broadband light source comprises:
generating broadband light with a laser-sustained plasma broadband light source.

15. The method of claim 13, wherein the hyperspectral camera assembly comprises:
a set of sensors and a set of filter plates positioned in front of the set of sensors, wherein a respective filter plate is positioned in front of a respective sensor.
